(19) United States
(12) Patent Application Publication
(10) Pub. No.: US 2006/0161785 A1
(43) Pub. Date: Jul. 20, 2006

(54) System and method for querying a network directory for information handling system user privileges

(76) Inventors: Christopher Conner, Jonestown, TX (US); Bradley Bransom, Round Rock, TX (US)

Correspondence Address: HAMILTON & TERRILE, LLP, P.O. BOX 203518, AUSTIN, TX, 78720, US

(21) Appl. No.: 11/039,011

(22) Filed: Jan. 20, 2005

(51) Int. Cl. H04L 9/00

(52) U.S. Cl. 713/182

(57) ABSTRACT

Information handling system access to a network product, such as a predetermined application, function or information, is controlled by a server administrator associated with the product and a privilege directory associated with the network. The privilege directory has plural association objects, each association object tied to one or more users or group of users and a single privilege. On receipt of a request from a user to access a product, the server administrator queries the privilege directory to determine all association objects tied to the requesting user and determines if a privilege to access the product is tied to an association object having the requesting user.

### BACKGROUND OF THE INVENTION

1. Field of the Invention

The present invention relates in general to the field of information handling system networks, and more particularly to a system and method for querying a Directory Service for information handling system user privileges.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often interact with each other and with peripherals through networks, such as Ethernet-based wire line networks or 802.11-based wireless networks. Businesses have found that networking information handling systems improves productivity by better managing information for the coordinated activities of employees. Often, business networks become quite large, supporting a substantial number of users across multiple servers and multiple locations. Typically, different users are provided with varying levels of access to network resources by defining specific privileges associated with each user. For instance, privileges define information approved for access by a user, such as sensitive business information having access limited to executives, officers or directors of the business, or sensitive personal information having access limited to human resources personnel. As another example, privileges define actions approved for access by a user, such as approval to set and alter system configurations limited to information technology administration. Often varying groups of employees are assigned varying privileges so that a given network user may belong to several groups with each group having one or more associated privileges.

One difficulty with having varying levels of privileges that govern access to a network is managing the users or groups of users associated with each privilege. Typically, user privileges are tracked in a network privilege directory database, such as the ACTIVE DIRECTORY database from MICROSOFT. A user who seeks to access a privilege through a network has the access confirmed through user privilege data stored in the network privilege directory. However, local configuration of user privileges presents a substantial network management challenge of keeping up with employees who join and leave a business and tends to detract from the convenience of a common directory database for controlling user accesses. In particular, defining cross-domain user groups is difficult, often requiring re-creation of user groups in each domain, a costly and time-consuming process. An alternative is to define universal groups that work across domains, however, defining and maintaining universal groups of users for more centralized management of network accesses also faces difficulties. For instance, universal groups replicated to an ACTIVE DIRECTORY Global Catalog causes bloat and requires that any changes to user access privileges be replicated to the global catalog before becoming effective, presenting security problems until replication is complete. For this and other reasons, information technology administrators tend to avoid using universal groups.

### SUMMARY OF THE INVENTION

Therefore a need has arisen for a system and method which queries a Directory Service for an information handling system user privilege to access a network product.

In accordance with the present invention, a system and method are provided which substantially reduce the disadvantages and problems associated with previous methods and systems for managing user privileges for access to a network with an information handling system. A server administrator queries a privilege directory to determine whether a user request to access a product is allowable. The server administrator retrieves association objects for the requested product, determines whether the requesting user is tied to the retrieved association objects and allows access by the user to the product if association objected tied to the product and the user has the privilege to access the product.

More specifically, an information handling system network communicates information across plural domains between server and user information handling systems. An open managed server administrator associated with a product of a first domain approves or disapproves access to the product by users of the first or other domains by reference to a network privilege directory. The privilege directory has plural association objects, each object tied to a product or products, a user or group of users, and a single privilege. The server administrator receives a user request for access to a product and retrieves all association objects of the privilege directory that are tied to the product. The server administrator identifies each of the retrieved association objects that are tied to the requesting user and then allows user access to the product if a privilege tied to one of these association objects includes a privilege to access the product. The product may include a predetermined application, function or information.

The present invention provides a number of important technical advantages. One example of an important technical advantage is that access to products is managed locally from a centralized privilege directory to provide improved support for cross-domain user product requests. Privilege directory queries proceeding from the server administrator through the product instances to identify association objects provides a direct query route for locating user instances of the product and privileges associated with the user instances. Network administrators may use and reuse groups to define user privileges for multiple products, allowing for efficient network administration.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system network having privileged access to a product managed through a privilege directory;

FIG. 2 depicts a privilege directory schema and query path; and

FIG. 3 depicts a process of querying a privilege directory to determine access by a requesting user to a privileged product.

### DETAILED DESCRIPTION

Information handling system access to a network product is managed by a query from a server administrator associated with the product to a privilege directory to determine whether a requesting user has a privilege to access the product. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

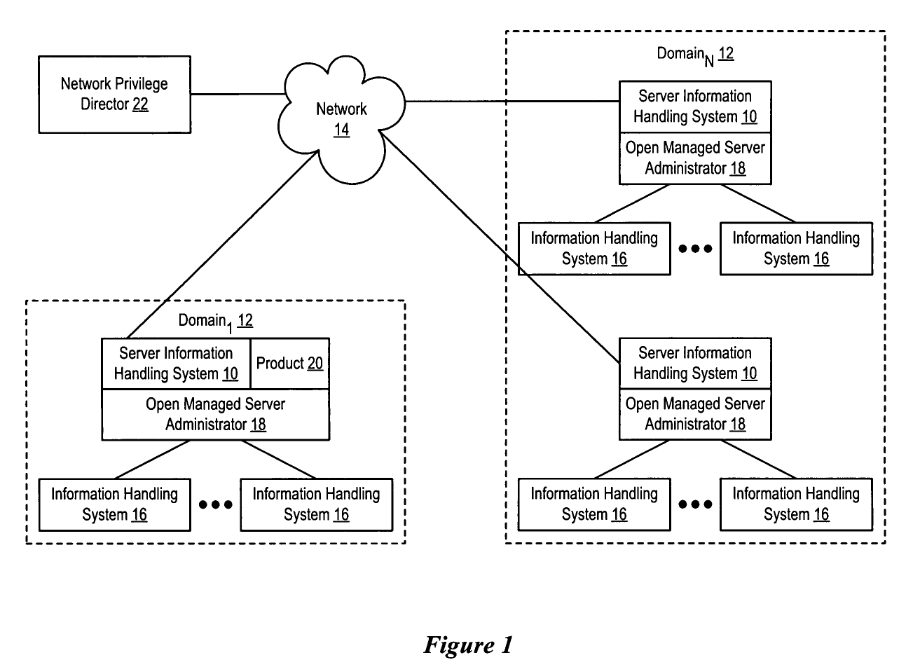

Referring now to FIG. 1, a block diagram depicts an information handling system network having privileged access to a product managed through a network privilege directory. Server information handling systems 10 grouped in domains 12 support communication of information over a network 14, such as a local and/or wide area network. Network users interface with network 14 through user information handling systems 16, which access network 14 through an open managed server administrator 18 running on a server information handling system 10. Open managed server administrator 18 approves or disapproves access by a user information handling system 16 to a product 20 based upon whether the requesting user has a privilege to access product 20. For instance, product 20 is a predetermined application, function or information requested by a user. Within a domain 12, user information handling systems 16 associated with the domain 12 may have user privilege data stored locally within the open managed server administrator 18 associated with the domain. However, where privileges are not stored locally or where a user request to access a product 20 comes from outside of the domain in which the product is located, reference to a network privilege directory 22 allows the open managed server administrator associated with the product 20 to determine a requesting user's privilege to access the product 20. For instance, network privilege directory 22 is a MICROSOFT ACTIVE DIRECTORY database that defines privileges that are tied to users and products of network 14.

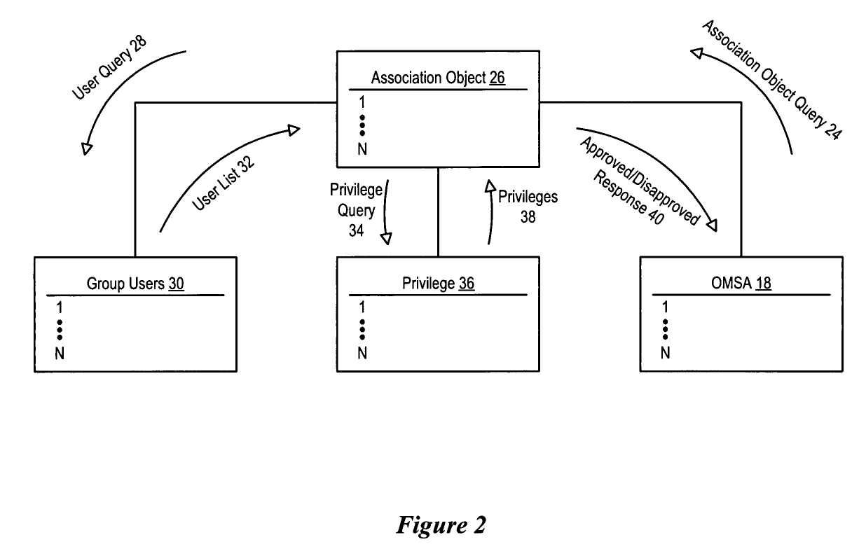

Referring now to FIG. 2, a privilege directory schema and query path are depicted to illustrate the queries that an open managed server administrator 18 makes to network privilege directory 22 to determine whether a user request to access a product is privileged. The query originates with the open managed server administrator 18 and proceeds in the direction of arrow 24 to request all association objects 26 tied to the product in network privilege directory 22. For each association object 26 tied to the requested product, a user query 28 retrieves all users or groups of users 30 that are tied to the identified association objects 26 and determines if the requesting user is tied to any of the identified association objects 26. A user list response 32 identifies each association object in which the user requesting access to the product is found. A privilege query 34 retrieves the privilege tied to each association object having the requesting user, with each association object having a single privilege tied to it. A list of privileges 38 are returned for the association objects tied to the product and the requesting user. If the privilege to access the product is on the list 38, an approval response 40 is provided to the open managed server administrator while, if the privilege to access the product is not on the list, a disapproval response 40 is returned.

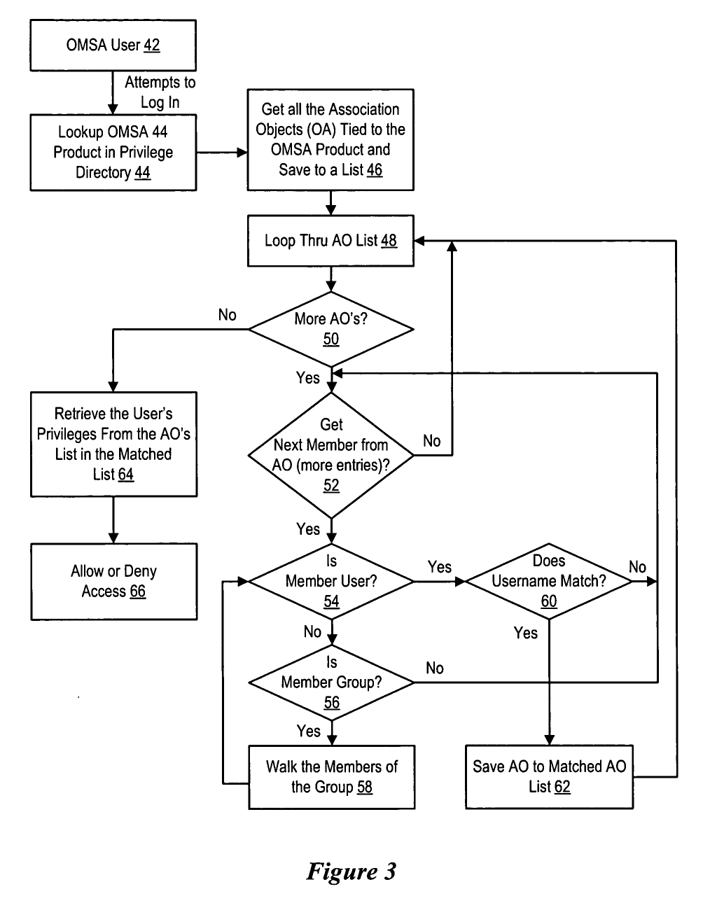

Referring now to FIG. 3, a flow diagram depicts a process of querying a privilege directory to determine access by a requesting user to a privileged product. The process begins at step 42 with an attempt by a user to log in to a product associated with an open managed server administrator. At step 44, the open managed server administrator looks up the product in the network privilege directory so that, at step 46, all association objects tied to the product are retrieved and saved to a list. The process continues to step 48 to loop through the list of association objects in order to identify association objects and privileges tied to the user. At step 50, if one or more association objects remain on the list, the process continues to step 52 to get the next member tied to the association object. If no additional members are tied to the association object, the process returns to step 48 to continue to the next association object. If a member is found at step 52, a determination is made at step 54 of whether the found member is a user. If the member tied to the association object is not a user, the process continues to step 56 to determine if the member is a group of users and, if so, to step 58 to walk the member of the group in a nested loop that identifies users. If at step 54 the member is a user, the process continues to step 60 to determine whether the user name matches the name of the user requesting access to the product. If a match occurs, the process continues to step 62 to a save the association object to a matched list and returns to step 48 to check the next association object on the list for a user match. If the user name does not match at step 60, or if no user names are found at step 56, the process returns to step 52 to continue through the members tied to the association object. Once all of the association objects are queried at step 50, the process continues to step 64 to retrieve the user's privileges of the association objects placed in the matched list at step 62. The retrieved privileges reflect the privileges of the association objects tied to the requesting user. At step 66, the user is allowed access to the requested product if the retrieved privileges include access to the product and denied access if the retrieved privileges do not include access to the product.

Although the present invention has been described in detail, it should be understood that various changes, substitutions and alterations can be made hereto without departing from the spirit and scope of the invention as defined by the appended claims.

What is claimed is:

1. An information handling system network comprising:
plural information handling system servers, at least one server having a product, the product associated with a privilege for access;
plural information handling systems associated with each server;
a network interfacing the information handling system servers and information handling systems;
a network privilege directory interfaced with the network and having plural association objects, at least one association object tied to the product, each association object containing one or more users and a privilege; and
a server administrator associated with the at least one server and operable to receive a user request to the product, to query the network privilege directory for association objects tied to the product and to grant access to the product in response to the user request if an association object tied to the product contains the user and the privilege to access the product.

2. The information handling system network of claim 1 wherein the product comprises access to predetermined information.

3. The information handling system network of claim 1 wherein the product comprises access to one or more predetermined applications.

4. The information handling system network of claim 1 wherein the network comprises plural domains, the product associated with a first domain and the user associated with a second domain.

5. The information handling system network of claim I wherein the network privilege directory comprises plural groups of users, each group of users tied to at least one association object.

6. The information handling system network of claim 5 wherein the server administrator is further operable to determine if the user associated with the request is in one or more of the groups of users.

7. A system for determining whether a user has a privilege to access a product of an information handling system, the system comprising:
a privilege directory having plural association objects, each association object tied to one or more products, one or more users and a privilege; and
a server administrator associated with the information handling system and operable to receive user requests to access the product, the server administrator further operable to:
query the privilege directory for all association objects tied to the requested product;
determine which of the queried association objects are tied to the user;
determine the privileges for the association objects tied to the user; and
allow access to the product if the determined privileges include a privilege to access the product.

8. The system of claim 7 wherein the product comprises a predetermined information.

9. The system of claim 7 wherein the product comprises a predetermined application.

10. The system of claim 7 wherein the product comprises a predetermined function.

11. The system of claim 7 wherein determining which of the queried association objects are tied to the user further comprises:
determining that a group of users are tied to an association object; and
walking the group of users to determine whether the requesting user is in the group.

12. The system of claim 7 wherein the server administrator is associated with a first domain and is further operable to receive user requests from outside of the first domain.

13. A method for determining whether a user has a privilege to access a product of an information handling system, the method comprising:
querying a privilege directory for all association objects tied to the requested product;
determining which of the queried association objects are tied to the user;
determining the privileges for the association objects tied to the user; and
allowing access to the product if the determined privileges include a privilege to access the product.

14. The method of claim 13 wherein the product comprises predetermined information.

15. The method of claim 13 wherein the product comprises a predetermined application.

16. The method of claim 13 wherein the product comprises a predetermined function.

17. The method of claim 13 wherein determining which of the queried association objects are tied to the user further comprises:
determining that a group of users are tied to an association object; and
walking the group of users to determine whether the requesting user is in the group.

18. The method of claim 13 wherein querying a privilege directory for all association objects tied to the requested product further comprises querying a privilege directory having privileges for plural domains.

19. The method of claim 13 further comprising:
querying the information handling system for access to the product from outside a domain associated with the information handling system.

20. The method of claim 19 wherein querying a privilege directory further comprises querying from the domain associated with the information handling system to a domain associated with the privilege directory.
